(19) United States
(12) Patent Application Publication
(10) Pub. No.: US 2015/0189602 A1
(43) Pub. Date: Jul. 2, 2015

(54) CORE LEVEL OPTIMIZED LOW POWER MODE

(71) Applicant: QUALCOMM Incorporated, San Diego, CA (US)

(72) Inventors: Sachin Dileep DASNURKAR, San Diego, CA (US); Prasad Rajeevalochanam BHADRI, San Diego, CA (US)

(21) Appl. No.: 14/340,230

(22) Filed: Jul. 24, 2014

Related U.S. Application Data
(60) Provisional application No. 61/923,191, filed on Jan. 2, 2014.

(51) Int. Cl. H04W 52/16

(52) U.S. Cl. CPC H04W 52/16

(57) ABSTRACT

A method for operating an electronic system, an integrated circuit on a substrate, and an apparatus including a memory and at least one processor coupled to the memory are provided. In one configuration, the at least one processor is configured to read, from an integrated circuit, first information of a first group including at least one core in a power domain and second information of a second group including at least one core in the power domain; to determine a voltage for the power domain in a low power mode based on the first information and the second information; and to configure power supply to provide the voltage for the power domain in the low power mode.

### CROSS-REFERENCE TO RELATED APPLICATION(S)

This application claims the benefit of U.S. Provisional Application Ser. No. 61/923,191, titled “METHOD AND APPARATUS FOR CORE LEVEL OPTIMIZED SLEEP MODE SPECIFICATION FOR OPTIMIZING STANDBY TIME” and filed on Jan. 2, 2014, which is expressly incorporated by reference herein in its entirety.

### BACKGROUND

1. Field

The disclosure relates to electronic apparatuses and, in particular, to electronic apparatuses with integrated circuits (ICs) containing multiple cores.

2. Background

Wireless communication technologies and devices (e.g., cellular phones, tablets, laptops, etc.) have grown in popularity and use over the past several years. Increasingly, mobile electronic devices have grown in complexity and now commonly include multiple processors (e.g., baseband processor and application processor) and other resources that allow mobile device users to execute complex and power intensive software applications (e.g., music players, web browsers, video streaming applications, etc.). To meet the increasing performance demand, the processors are designed to include multiple cores. For example, each integrated circuit (IC) substrate of the processor may include multiple cores. An example of such core includes a central processing unit (CPU) and its own cache.

With the ever increasing demand for more processing capability in the wireless devices, low power consumption has become a common design requirement. Various techniques are currently being employed to reduce power consumption in such devices. One example of such techniques includes placing an inactive core into a low power mode, which limits the supply voltages to the core. As a result, the core in such low power mode draws reduced currents.

### SUMMARY

Aspects of a method for operating an electronic apparatus are disclosed. The method includes reading, from an integrated circuit, first information of a first group including at least one core in a power domain and second information including a second group of at least one core in the power domain. The method further includes determining a voltage for the power domain in a low power mode based on the first information and the second information and configuring a power supply to provide the voltage for the power domain in the low power mode.

Aspects of an apparatus including a memory and at least one processor coupled to the memory are disclosed. The at least one processor is configured to read, from an integrated circuit, first information of a first group including at least one core in a power domain and second information of a second group including at least one core in the power domain; to determine a voltage for the power domain in a low power mode based on the first information and the second information; and to configure power supply to provide the voltage for the power domain in the low power mode.

Aspects of an integrated circuit on a substrate are provided. The integrated circuit includes a first core and a second core in a common power domain. A power supply is configured to supply a voltage to the common power domain in a low power mode. A memory stores first information of a first group including at least the first core and second information of a second group including at least the second core. The voltage supplied to the common power domain in a low power mode is based on the first information or the second information.

It is understood that other aspects of apparatus and methods will become readily apparent to those skilled in the art from the following detailed description, wherein various aspects of apparatus and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

FIG. 1 illustrates a wireless communication device and communication systems in which an exemplary embodiment may be included.

FIG. 2 is a block diagram of a wireless communication device in which an exemplary embodiment may be included.

FIG. 3 is a block diagram illustrating an exemplary embodiment for grouping the cores.

FIG. 4 is a flow chart of an exemplary embodiment for reading information and configuring a power supply.

FIG. 5 is a conceptual data flow diagram illustrating the data flow between different modules/means/components in an exemplary apparatus.

FIG. 6 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. The term “exemplary” is used herein to mean “serving as an example, instance, or illustration.” Any design described herein as “exemplary” is not necessarily to be construed as preferred or advantageous over other designs.

Several aspects of IC design will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), electronically erasable programmable ROM (EEPROM), compact disk (CD) ROM (CD-ROM), or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

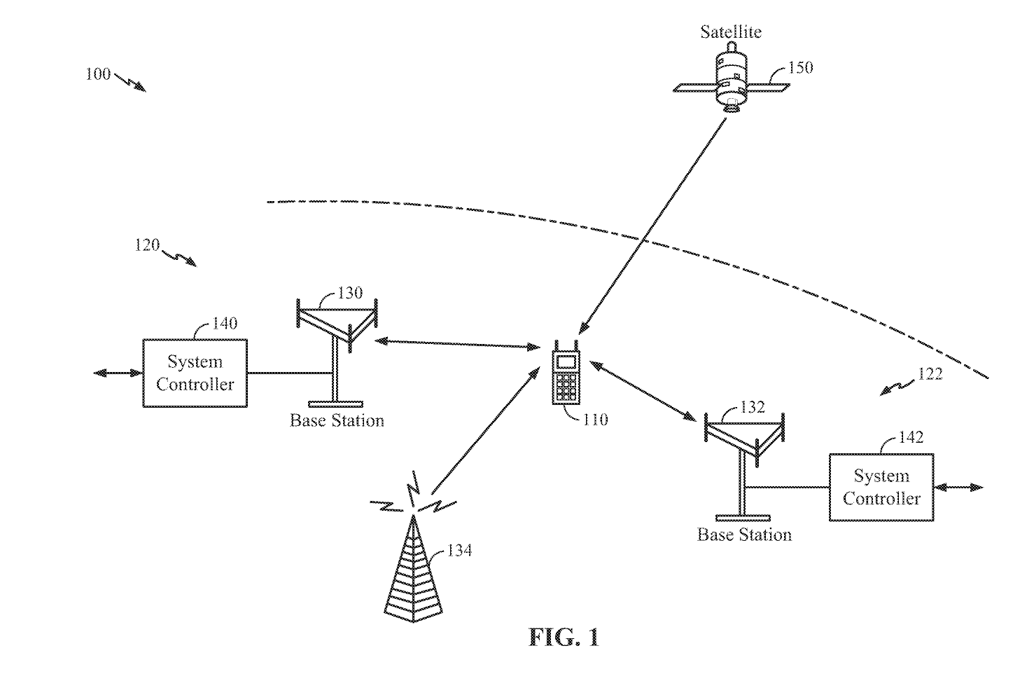

FIG. 1 illustrates a wireless communication device (e.g., wireless device 110) and communication systems (e.g., wireless systems 120 and 122) in which an exemplary embodiment may be included. The wireless systems 120, 122 may each be a Code Division Multiple Access (CDMA) system, a Global System for Mobile Communications (GSM) system, a Long Term Evolution (LTE) system, a wireless local area network (WLAN) system, or some other wireless system. A CDMA system may implement Wideband CDMA (WCDMA), CDMA 1X or cdma2000, Time Division Synchronous Code Division Multiple Access (TD-SCDMA), or some other version of CDMA. TD-SCDMA is also referred to as Universal Terrestrial Radio Access (UTRA) Time Division Duplex (TDD) 1.28 Mcps Option or Low Chip Rate (LCR). LTE supports both frequency division duplexing (FDD) and time division duplexing (TDD). For example, the wireless system 120 may be a GSM system, and the wireless system 122 may be a WCDMA system. As another example, the wireless system 120 may be an LTE system, and the wireless system 122 may be a CDMA system.

For simplicity, the diagram 100 shows the wireless system 120 including one base station 130 and one system controller 140, and the wireless system 122 including one base station 132 and one system controller 142. In general, each wireless system may include any number of base stations and any set of network entities. Each base station may support communication for wireless devices within the coverage of the base station. The base stations may also be referred to as a Node B, an evolved Node B (eNB), an access point, a base transceiver station, a radio base station, a radio transceiver, a transceiver function, a basic service set (BSS), an extended service set (ESS), or some other suitable terminology. The wireless device 110 may also be referred to as a user equipment (UE), a mobile device, a remote device, a wireless device, a wireless communications device, a station, a mobile station, a subscriber station, a mobile subscriber station, a terminal, a mobile terminal, a remote terminal, a wireless terminal, an access terminal, a client, a mobile client, a mobile unit, a subscriber unit, a wireless unit, a remote unit, a handset, a user agent, or some other suitable terminology. The wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, or some other similar functioning device.

The wireless device 110 may be capable of communicating with the wireless system 120 and/or 122. The wireless device 110 may also be capable of receiving signals from broadcast stations, such as the broadcast station 134. The wireless device 110 may also be capable of receiving signals from satellites, such as the satellite 150, in one or more global navigation satellite systems (GNSS). The wireless device 110 may support one or more radio technologies for wireless communication such as GSM, WCDMA, cdma2000, LTE, 802.11, etc. The terms “radio technology,” “radio access technology,” “air interface,” and “standard” may be used interchangeably.

The wireless device 110 may communicate with a base station in a wireless system via the downlink and the uplink. The downlink (or forward link) refers to the communication link from the base station to the wireless device, and the uplink (or reverse link) refers to the communication link from the wireless device to the base station. A wireless system may utilize TDD and/or FDD. For TDD, the downlink and the uplink share the same frequency, and downlink transmissions and uplink transmissions may be sent on the same frequency in different time periods. For FDD, the downlink and the uplink are allocated separate frequencies. Downlink transmissions may be sent on one frequency, and uplink transmissions may be sent on another frequency. Some exemplary radio technologies supporting TDD include GSM, LTE, and TD-SCDMA. Some exemplary radio technologies supporting FDD include WCDMA, cdma2000, and LTE.

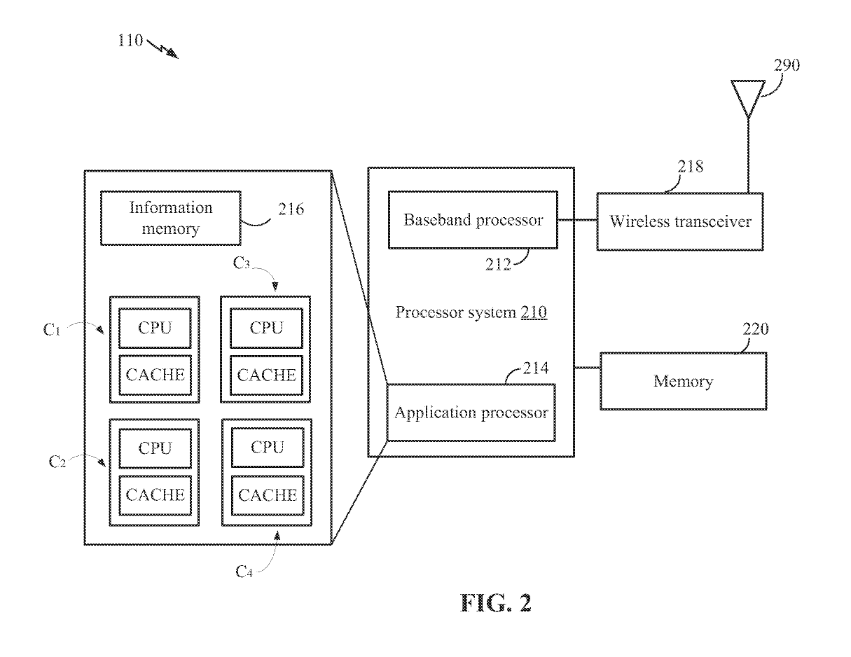

FIG. 2 illustrates a block diagram of a wireless communication device (such as the wireless device 110) in which an exemplary embodiment may be included. The wireless transceiver 218 communicates with an antenna 290 for supporting the various wireless bi-directional communications described above. For example, the wireless transceiver 218 performs the radio frequency (RF) functions of the wireless device 110. The wireless transceiver 218 may receive a digital signal for transmission from the baseband processor 212, and convert the digital signal to an analog RF signal. The analog RF signal is provided to the antenna 290 for transmission. The wireless transceiver 218 may further receive an RF signal from the antenna 290 and convert it to a digital signal. The wireless transceiver 218 may provide the digital signal to the baseband processor 212 for processing.

The wireless device 110 includes the processor system 210, which includes the baseband processor 212 and the application processor 214. The baseband processor 212 communicates with the wireless transceiver 218. In one example, the baseband processor 212 receives data (e.g., from the application processor 214) for transmission and modulates the data. The modulated data is provided to the wireless transceiver 218 as the digital signal for transmission. The baseband processor 212 may further receive a digital signal from the wireless transceiver 218. The baseband processor 212 may demodulate the received digital signal and obtain the data carried by the digital signal. The application processor 214 operates and processes the various functions of the wireless device 110 (e.g., music player, web browsers, video streaming applications, etc.). In that regard, the application processor 214 may include a graphic unit for displaying an image, a global positioning unit for locating the wireless device 110, an audio unit for telephony and music applications, and/or a connectivity unit for WiFi, near field communication, and Bluetooth functions. The processor system 210 communicates with the memory 220. Examples of the memory 220 include static random access memory (SRAM), dynamic random access memory (SRAM), flash memory, read only memory (ROM), registers, a hard disk, a removable disk, a CD-ROM, and so forth.

As an example, the application processor 214 includes four cores C₁-C₄. In one example, each of the four cores C₁-C₄ is a collection of circuits. In another example, each of the four cores C₁-C₄ includes an execution unit that manipulates (e.g., adds, subtracts, moves, or stores) data as instructed by, e.g., software. Each of the cores may be assigned or be dedicated to, e.g., the graphic function for displaying an image, a global positioning function for locating the wireless device 110, an audio function for telephony and music applications, and/or a connectivity function. As shown, each of the four cores C₁-C₄ includes a CPU (which includes an execution unit) and its own cache. The cache may be an instruction cache, a data cache, or both. The application processor 214 further includes an information memory 216 for storing information concerning the cores C₁-C₄. The information memory 216 may be non-volatile memories such as a programmable ROM or a fuse set. In one example, a core may be assigned or be dedicated to a graphic function for displaying an image, a global positioning function for locating the wireless device 110, an audio function for telephony and music applications, and/or a connectivity function for WiFi, near field communication, and Bluetooth functions. While the application processor 214 in a wireless device 110 is cited as an example here, a person of ordinary skill in the art would readily recognize that the scope of this disclosure is limited neither to an application processor nor to a wireless device.

Embodiments described herein provide for methods and apparatus to minimize powers supplied to the cores in a low power mode. For example, embodiments provide for characterizing the cores for electrical characteristics (e.g., for each core, a threshold voltage required for the low power mode). In another example, the electrical characteristics may include indications of whether a core requires data retention in the low power mode, and/or a threshold voltage for the core to retain data in the low power mode. The electrical characteristics for each core of the processor (e.g., application processor 214) are then stored on the processor (e.g., the information memory 216). An apparatus (e.g., wireless device 110) incorporating the processor may then read back the stored information and configure a power supply for a power domain, based on the read information.

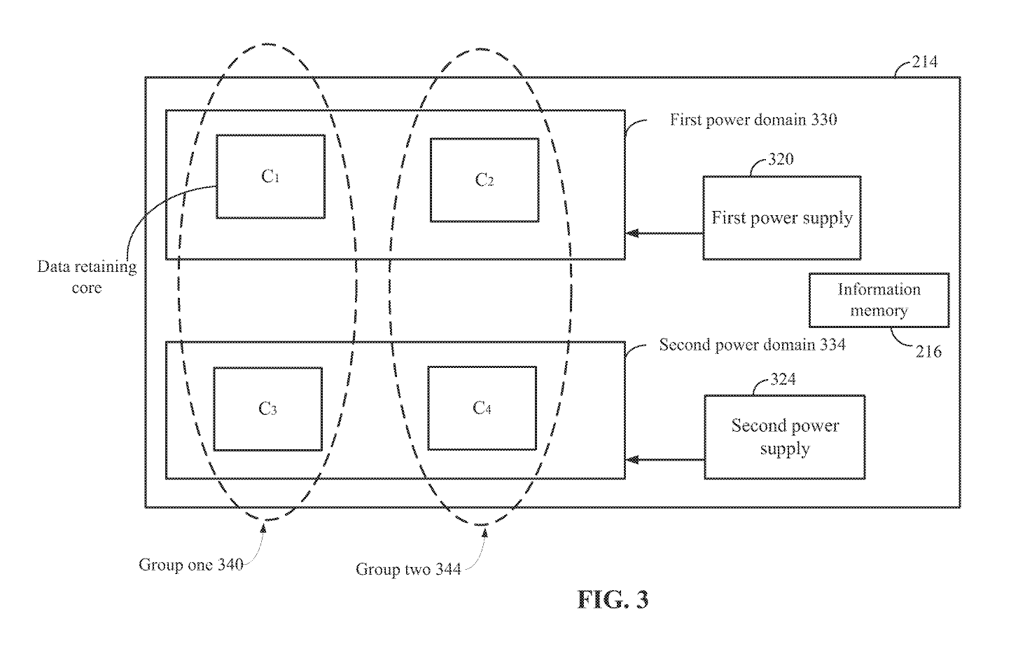

FIG. 3 is a block diagram illustrating an exemplary embodiment for grouping the cores. The application processor 214 includes the cores C₁ and C₂ in the first power domain 330 and the cores C₃ and C₄ in the second power domain 334. A power domain, for example, may be a group of circuits or cores which share a common set of power supplies. For example, the first power supply 320 provides power (e.g., voltage) to the first power domain 330, and therefore, cores C₁ and C₂, for operation. In a low power mode, the first power supply 320 may be configured to provide to the first power domain 330 a lower voltage than an operating voltage (thereby reduces the power drain in the low power mode). The second power supply 324 provides power to the second power domain 334, and therefore, cores C₃ and C₄, for operation. In a low power mode, the second power supply 324 may be configured to provide to the second power domain 334 a lower voltage than an operating voltage (thereby reduces the power drain in the low power mode).

The application processor 214 may be characterized to obtain electrical characteristics of the cores (e.g., C₁, C₂, C₃, and C₄). Typically, an automatic testing equipment (ATE) is used for testing and characterization. In one example, the electrical characteristics may include a threshold voltage required for the low power mode for a core. The core may need to be maintained at a voltage (lower than the operating voltage) in the low power mode. For example, certain voltage biasing in the core may need to be maintained in the low power mode, or the wake up time upon exiting low power mode may be exceedingly long. In this example, the threshold voltage for the core may be one that is enough to maintain the voltage biasing in the low power mode. In another example, the electrical characteristics may include indications of whether a core requires data retention in the low power mode, and/or a threshold voltage for the core to retain data in the low power mode.

The cores C₁, C₂, C₃, and C₄ are grouped based on the electrical characteristics. The group one 340 includes cores C₁ and C₃, and the group two 344 includes cores C₂ and C₄. In one example, the cores may be grouped based on similar threshold voltages in the low power mode. For example, the group one 340 including cores C₁ and C₃ may be satisfied with a first threshold voltage in the low power mode, while the group two 344 including cores C₂ and C₄ may be satisfied with a second threshold voltage in the low power mode. While the groups are shown with two cores each, the grouping is not so limited. A group may include just one core or more than two cores.

The information relating to the electrical characteristics associated with the cores and/or the groups may be stored in the information memory 216. In one example, the wireless device 110 incorporating the application processor 214 may instruct the application processor 214 to read the information stored in the information memory 216. The application processor 214 may further configure the first power supply 320 and/or the second power supply 324 to provide the first threshold voltage to the first power domain 330 and/or the second threshold voltage to the second power domain 340 in the low power mode, based on the stored information.

In another aspect of the disclosure, information relating to data retention is characterized and stored. Certain cores may need to retain data during the low power mode. For example, a graphic processing core (whether dedicated to graphic processing or assigned to perform graphic processing) may need to retain graphic data to allow the wireless device 110 to return quickly from idling. For example, the wireless device 110 may need to recall the graphic on a web page when returning from idling. In this regard, the graphic processing core retaining the graphic data would shorten the recall process. In another example, a connectivity core (whether dedicated to the connectivity function or assigned to the connectivity function) may not need to retain the data in the low power mode. In this example, the threshold voltage for the connectivity core in the low power mode may be lower than the threshold voltage for retaining data. In another aspect, the data retention may be further based on an application operating on the application processor 214. In the example above, the application currently operating on the application processor 214 may not need the graphic function. In this case, the graphic processing core would not be a data retaining core.

In one example, the wireless device 110 may instruct the application processor 214 to determine a threshold voltage for the first power domain 330 and/or the second power domain 334 for the low power mode based on the information stored in the information memory 216, as described above. For example, the information may indicate a first threshold voltage for the group one 340 and/or a second threshold voltage for the group two 344 in the low power mode. In one aspect, the voltage for the power domain (e.g., first power domain 330 or second power domain 334) in the low power mode is based on a threshold voltage of a data retaining core in the low power mode. For example, based on the information stored in the information memory 216, the application processor 214 may determine that the core C₁ is a data retention core. The application processor 214 may determine the low power mode threshold voltage for the group one 340 and the first power domain 330 based on the data retention voltage of the core C₁. The data retention voltage of the core C₁ may be, for example, a threshold voltage that allows the core C₁ to retain data in the low power mode.

In another example, the voltage for the power domain (e.g., first power domain 330 or second power domain 334) in the low power mode may be further based on an application. As described above, whether a core is a data retention core may be determined based on the current application operating on the application processor 214. The wireless device 110 may instruct the application processor 214 to configure the first power supply 320 to provide the first threshold voltage for the first power domain 330 in the low power mode and/or to configure the second power supply 324 to provide the second threshold voltage for the second power domain 334 in the low power mode.

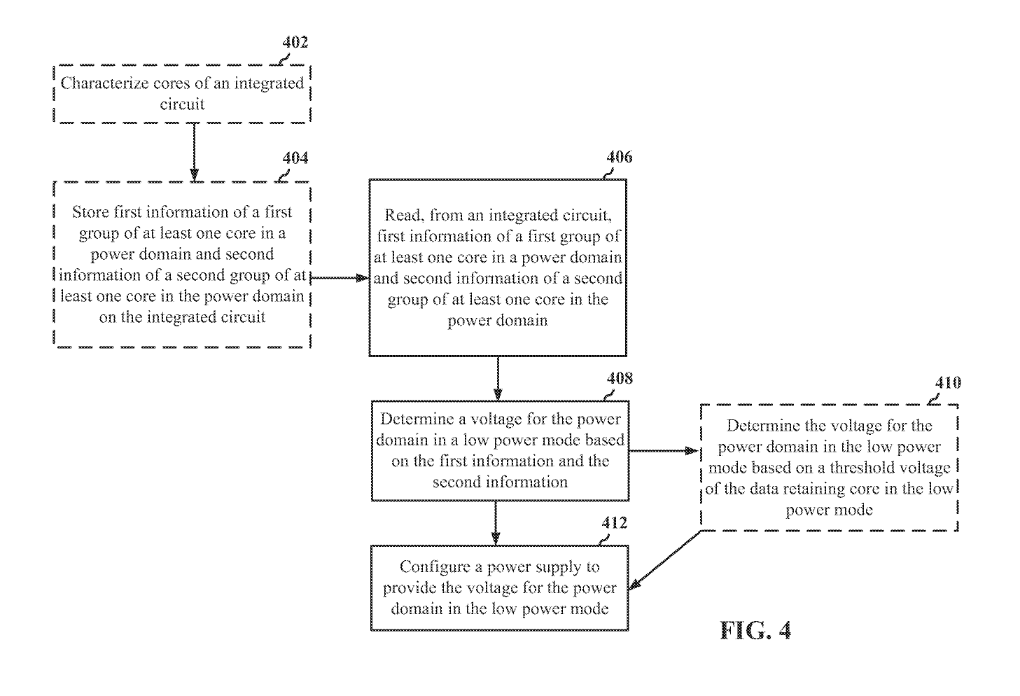

FIG. 4 is a flow chart of an exemplary embodiment for reading information and configuring a power supply (e.g., the first power supply 320 and/or the second power supply 324). The steps boxed in dotted line may be optional. The steps may be performed by an apparatus such as the wireless device 112 and/or the application processor 214, as described with FIG. 3. At 402, cores of an integrated circuit are characterized. For example, an ATE may characterize the cores C₁, C₂, C₃, and C₄ of an integrated circuit including the application processor 214. At 404, first information of a first group including at least one core in a power domain and second information of a second group including at least one core in the power domain are stored on the integrated circuit. For example, the ATE may store information from the characterization of the cores in the information memory 216 of the application processor 214. At 406, the first information of the first group including at least one core in the power domain and the second information of the second group including at least one core in the power domain are read from the integrated circuit. For example, the wireless device 110 incorporating the application processor 214 may instruct the application processor 214 to read the first information of a first group (e.g., group one 340) including at least one core (e.g., core C₁ or C₃) in a power domain (e.g., first power domain 330) and the second information of a second group (e.g., group two 344) including at least one core (e.g., core C₂ or C₄) in the power domain. At 408, a voltage for the power domain in a low power mode is determined based on the first information and the second information. For example, the wireless device 110 incorporating the application processor 214 may instruct the application processor 214 to determine a voltage for the first power domain 330 based on the first information and the second information as described with FIG. 3. At 410, the determined voltage for the power domain in the low power mode is based on a threshold voltage of the data retaining core in the low power mode. Examples of the step are as described with FIG. 3. At 412, a power supply to provide the voltage for the power domain in the low power mode is configured. For example, the wireless device 110 incorporating the application processor 214 may instruct the application processor 214 to configure the first power supply 320 to supply the determined voltage to the first power domain 330 in the low power mode.

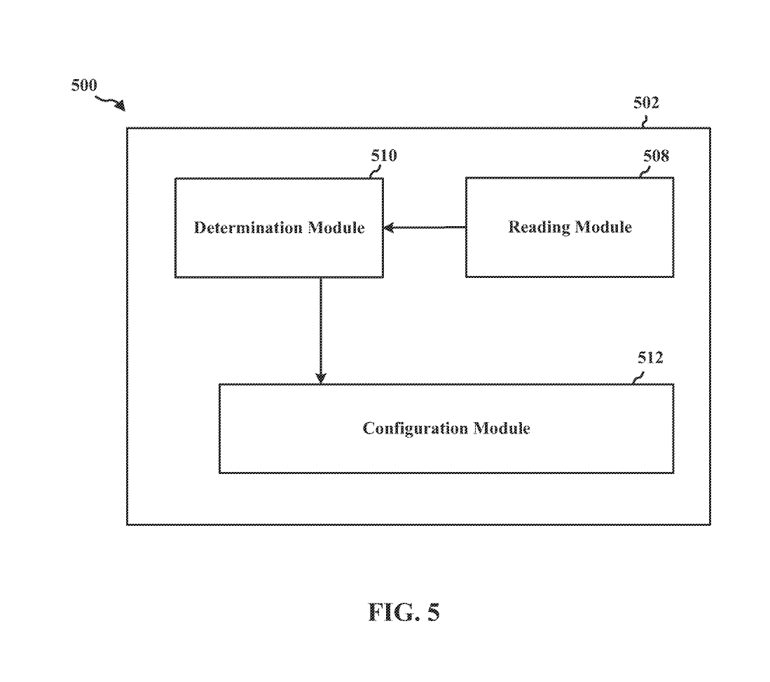

FIG. 5 is a conceptual data flow diagram 500 illustrating the data flow between different modules/means/components in an exemplary apparatus 502. The apparatus 502 may be a computer or a processor coupled to a memory for initiating the modules in hardware or software. For example, for a firmware and/or software implementation, the methodologies may be implemented with the modules (e.g., procedures, functions, and the like) that perform the steps described in FIG. 4. Any machine-readable medium tangibly embodying instructions may be used in implementing this routine. The apparatus 502 includes a reading module 508 that reads, from an integrated circuit, from an integrated circuit, first information of a first group including at least one core in a power domain and second information of a second group including at least one core in the power domain. A determination module 510 determines a voltage for the power domain in a low power mode based on the first information and the second information. A configuration module 512 configures a power supply to provide the voltage for the power domain in the low power mode.

The apparatus may include additional modules that perform (or provide the means for) each of the steps of the algorithm in the aforementioned flow chart of FIG. 4. As such, each step in the aforementioned flow chart of FIG. 4 may be performed by a module and the apparatus may include one or more of those modules. For example, the reading module 508 provides the means for reading, from an integrated circuit, first information of a first group including at least one core in a power domain and second information of a second group including at least one core in the power domain. The determination module 510 provides the means for determining a voltage for the power domain in a low power mode based on the first information and the second information. The configuration module 512 provides the means for configuring a power supply to provide the voltage for the power domain in the low power mode. The modules may be one or more hardware components specifically configured to carry out the stated processes/algorithm, implemented by a processor configured to perform the stated processes/algorithm, stored within a computer-readable medium for implementation by a processor, or some combination thereof.

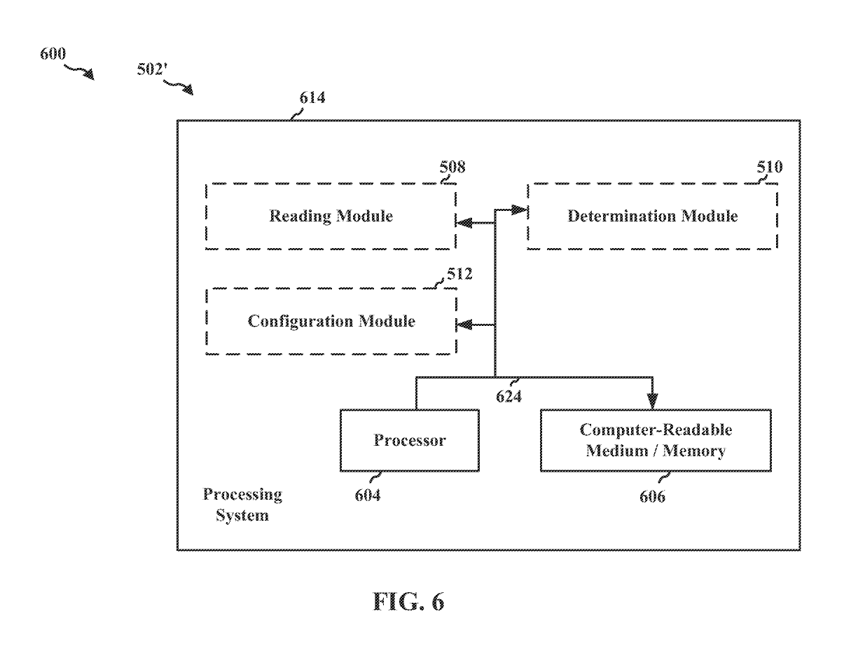

FIG. 6 is a diagram 600 illustrating an example of a hardware implementation for an apparatus 502′ employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 604, the modules 508, 510, 512 and the computer-readable medium/memory 606. The bus 624 may also link various other circuits such as timing sources, peripherals, voltage regulators, and power management circuits, which are well known in the art, and therefore, will not be described any further.

The processing system 614 includes a processor 604 coupled to a computer-readable medium/memory 606. The processor 604 is responsible for general processing, including the execution of software stored on the computer-readable medium/memory 606. The software, when executed by the processor 604, causes the processing system 614 to perform the various functions described supra for any particular apparatus. The computer-readable medium/memory 606 may also be used for storing data that is manipulated by the processor 604 when executing software. The processing system further includes at least one of the modules 508, 510, and 512. The modules may be software modules running in the processor 604, resident/stored in the computer readable medium/memory 606, one or more hardware modules coupled to the processor 604, or some combination thereof.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An method for operating an electronic system, comprising:
reading, from an integrated circuit, first information of a first group including at least one core in a power domain and second information of a second group including at least one core in the power domain;
determining a voltage for the power domain in a low power mode based on the first information and the second information; and
configuring a power supply to provide the voltage for the power domain in the low power mode.

2. The method of claim 1, wherein the at least one core of the first group or the at least one core of the second group is a data retaining core in the low power mode.

3. The method of claim 2, wherein the first information indicates a threshold voltage for the first group in the low power mode and the second information indicates a threshold voltage for the second group in the low power mode.

4. The method of claim 3, wherein the voltage for the power domain in the low power mode is based on a threshold voltage of the data retaining core in the low power mode.

5. The method of claim 4, wherein the voltage for the power domain in the low power mode is further based on an application.

6. The method of claim 1, wherein the reading the first information and the second information comprises reading from a non-volatile memory storing the first information and the second information.

7. The method of claim 6, wherein the non-volatile memory storing the first information and the second information comprises a fuse set.

8. An apparatus, comprising:
a memory; and
at least one processor coupled to the memory and configured to:
read, from an integrated circuit, first information of a first group including at least one core in a power domain and second information including a second group of at least one core in the power domain;
determine a voltage for the power domain in a low power mode based on the first information and the second information; and
configure a power supply to provide the voltage for the power domain in the low power mode.

9. The apparatus of claim 8, wherein the at least one core of the first group or the at least one core of the second group is a data retaining core in the low power mode.

10. The apparatus of claim 9, wherein the first information indicates a threshold voltage for the first group in the low power mode and the second information indicates a threshold voltage for the second group in the low power mode.

11. The apparatus of claim 10, wherein the voltage for the power domain in the low power mode is based on a threshold voltage of the data retaining core in the low power mode.

12. The apparatus of claim 11, wherein the voltage for the power domain in the low power mode is further based on an application.

13. The apparatus of claim 8, wherein the at least one processor is configured to read the first information and the second information by reading from the memory storing the first information and the second information.

14. An integrated circuit on a substrate, comprising:
a first core and a second core in a common power domain;
a power supply configured to supply a voltage to the common power domain in a low power mode; and
a memory storing first information of a first group including at least the first core and second information of a second group including at least the second core, wherein the voltage supplied to the common power domain in the low power mode is based on the first information or the second information.

15. The integrated circuit of claim 14, wherein the first core or the second core is a data retaining core in the low power mode.

16. The integrated circuit of claim 15, wherein the first information indicates a threshold voltage for the first group in the low power mode and the second information indicates a threshold voltage for the second group in the low power mode.

17. The integrated circuit of claim 16, wherein the voltage for the common power domain in the low power mode is based on a threshold voltage of the data retaining core in the low power mode.

18. The integrated circuit of claim 17, wherein the voltage for the common power domain in the low power mode is further based on an application.

19. The integrated circuit of claim 14, wherein the memory comprises a non-volatile memory.

20. The integrated circuit of claim 19, wherein the non-volatile memory comprises a fuse set.
